(19) United States
(12) Patent Application Publication
(10) Pub. No.: US 2021/0044678 A1
(43) Pub. Date: Feb. 11, 2021

(54) OPTIMIZED QUIC FALLBACK ON ACCESS NETWORKS AND ENDPOINTS

(71) Applicant: Cisco Technology, Inc., San Jose, CA (US)

(72) Inventors: Prashanth Patil, San Jose, CA (US); Rajesh Indira Viswambharan, Bangalore (IN); Ram Mohan Ravindranath, Bangalore (IN)

(21) Appl. No.: 16/536,679

(22) Filed: Aug. 9, 2019

(51) Int. Cl. H04L 29/06; H04L 29/12

(52) U.S. Cl. CPC H04L 69/164; H04L 63/0236; H04L 61/1511; H04L 69/165

(57) ABSTRACT

In one embodiment, a domain name system (DNS) service receives a DNS request sent by a client for a particular destination. The DNS service determines that a connection between the client and the particular destination will not support use of the Quick User Datagram Protocol (UDP) Internet Connections (QUIC) protocol. The DNS service generates a DNS response to the DNS request that includes an indication that the connection between the client and the particular destination will not support use of the QUIC protocol within an Extensions Mechanisms for DNS (EDNS) field of the DNS response. The DNS service sends the DNS response, to cause an intermediary between the client and the particular destination to explicitly reject a QUIC protocol connection attempted by the client with the particular destination.

### TECHNICAL FIELD

The present disclosure relates generally to computer networks, and, more particularly, to optimized Quick User Datagram Protocol (UDP) Internet Connections (QUIC) fallback on access networks and endpoints.

### BACKGROUND

The recently introduced Quick User Datagram Protocol (UDP) Internet Connections (QUIC) protocol offers an alternative to using the Transport Layer Protocol (TCP) for web applications. More specifically, under TCP, if any of the multiplexed data streams encounter an error, the entire connection may be treated as failed. QUIC attempts to alleviate these issues by multiplexing connections using UDP and letting the QUIC driver handle errors, instead of the transmission protocol. In addition, QUIC supports including keying information within the initial handshake, as opposed to Transport Layer Security (TLS), which requires a separate handshake to secure the connection.

Despite the benefits of QUIC, many networks, especially enterprise networks, may not accommodate QUIC traffic. Indeed, many networks simply block all outgoing UDP traffic because it is extremely difficult to identify traffic patterns flowing through the network. In addition, some browsers and applications now attempt to use QUIC for all connections, without prior knowledge of QUIC support on the corresponding servers. In turn, the client may have to wait for the QUIC connection to time out, before falling back to using TCP. This approach can lead to considerable degradation of performance, particular in the case of constrained environments.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example network;

FIG. 2 illustrates an example network device/node;

FIGS. 3A-3B illustrate example flow diagrams for optimized QUIC fallback in an access network;

FIG. 4 illustrates an example flow diagram for optimized QUIC fallback on a local client; and

FIG. 5 illustrates an example simplified procedure for causing the explicit rejection of a QUIC connection.

### DESCRIPTION OF EXAMPLE EMBODIMENTS

### Overview

According to one or more embodiments of the disclosure, a domain name system (DNS) service receives a DNS request sent by a client for a particular destination. The DNS service determines that a connection between the client and the particular destination will not support use of the Quick User Datagram Protocol (UDP) Internet Connections (QUIC) protocol. The DNS service generates a DNS response to the DNS request that includes an indication that the connection between the client and the particular destination will not support use of the QUIC protocol within an Extensions Mechanisms for DNS (EDNS) field of the DNS response. The DNS service sends the DNS response, to cause an intermediary between the client and the particular destination to explicitly reject a QUIC protocol connection attempted by the client with the particular destination.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may further be interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless networks. That is, in addition to one or more sensors, each sensor device (node) in a sensor network may generally be equipped with a radio transceiver or other communication port, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

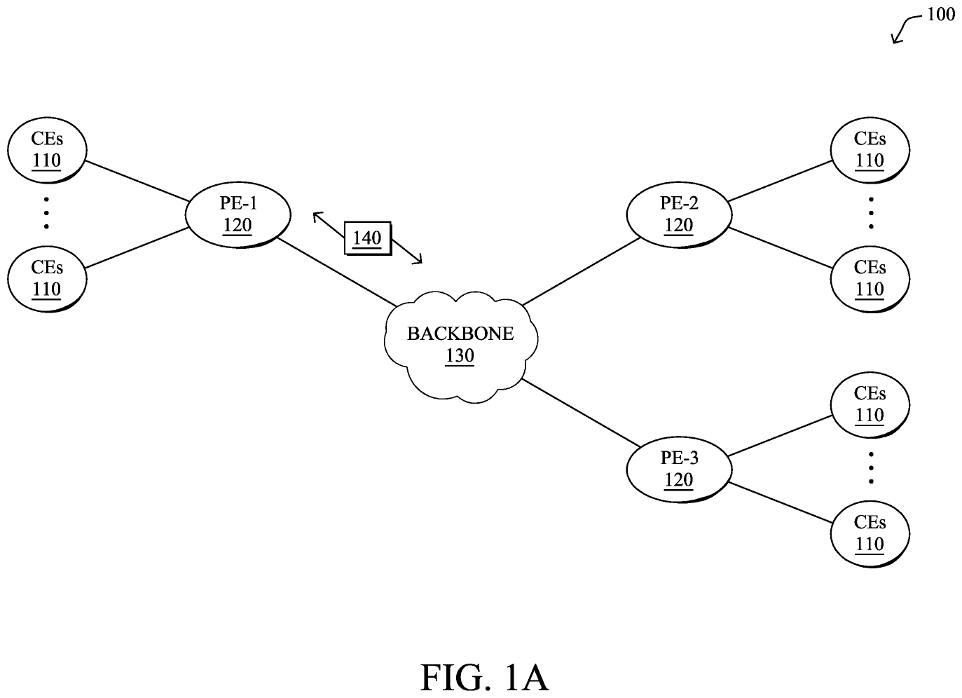

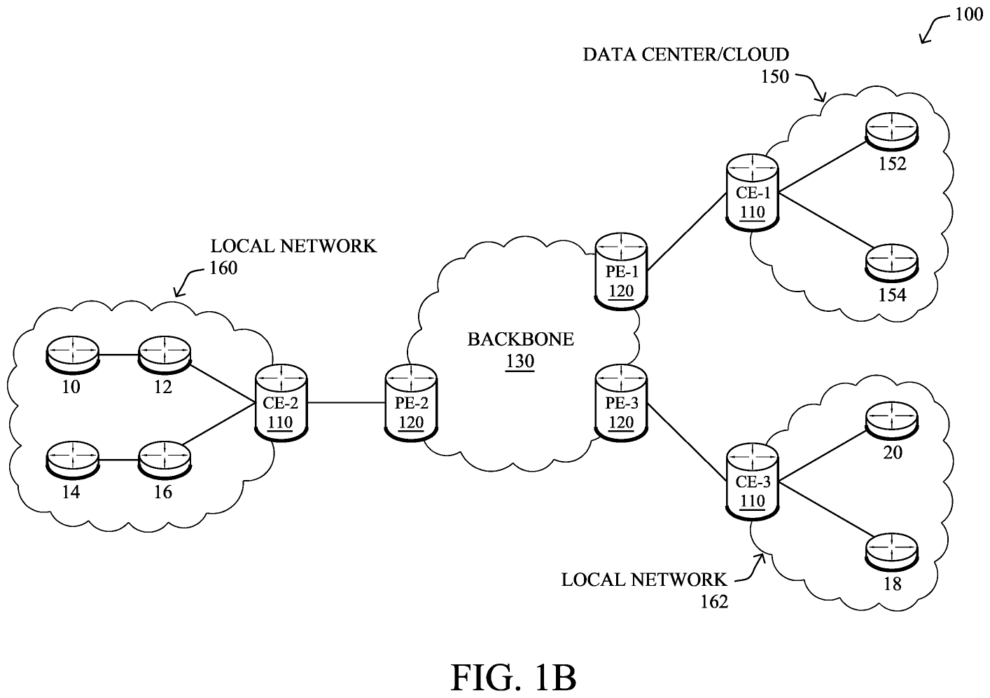

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN, thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network using two MPLS VPN links using a single CE router (e.g., from different service providers), with potentially a backup link (e.g., a 3G/4G/5G/LTE connection). A site of type B may itself be of different types:

2a.) Site Type B1: a site connected to the network using two MPLS VPN links (e.g., from different service providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, a Domain Name System (DNS) server, etc. As would be appreciated, network 100 may include any number of local networks, data centers, cloud environments, devices/nodes, servers, etc.

The techniques herein may also be applied to other network topologies and configurations. For example, the techniques herein may be applied to peering points with high-speed links, data centers, etc. Further, in various embodiments, network 100 may include one or more mesh networks, such as an Internet of Things network. Loosely, the term “Internet of Things” or “IoT” refers to uniquely identifiable objects/things and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless networks, etc., are often on what is referred to as Low-Power and Lossy Networks (LLNs), which are a class of network in which both the routers and their interconnect are constrained. In particular, LLN routers typically operate with highly constrained resources, e.g., processing power, memory, and/or energy (battery), and their interconnections are characterized by, illustratively, high loss rates, low data rates, and/or instability. LLNs are comprised of anything from a few dozen to thousands or even millions of LLN routers, and support point-to-point traffic (e.g., between devices inside the LLN), point-to-multipoint traffic (e.g., from a central control point such at the root node to a subset of devices inside the LLN), and multipoint-to-point traffic (e.g., from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

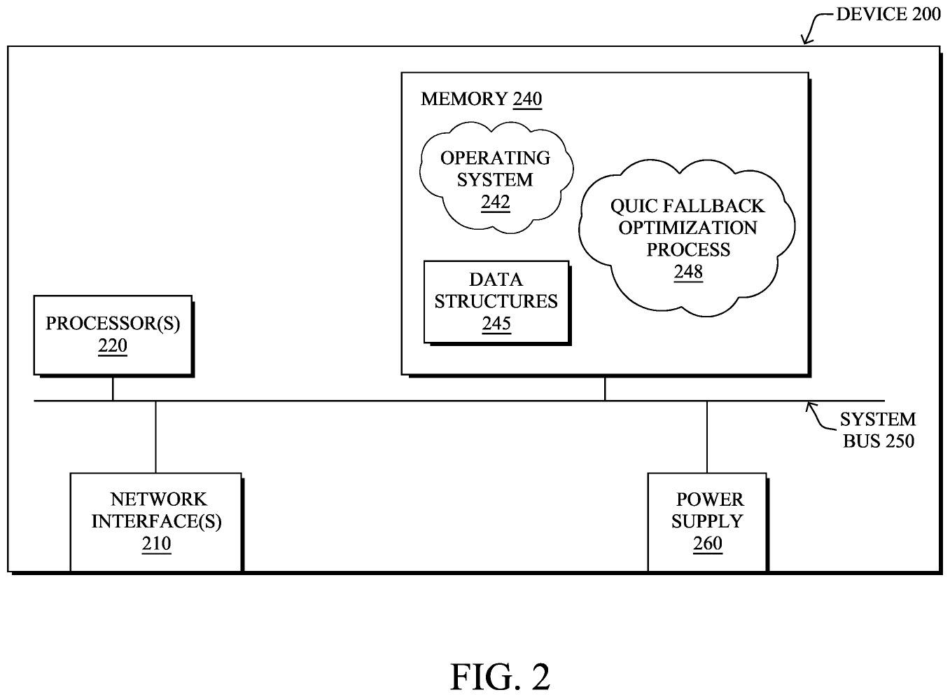

FIG. 2 is a schematic block diagram of an example node/device 200 that may be used with one or more embodiments described herein, e.g., as any of the computing devices shown in FIGS. 1A-1B and/or any of those described below (e.g., a device that provides a DNS service, a firewall, a network controller, etc.). The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a QUIC fallback optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, the Quick UDP Internet Connections (QUIC) protocol was recently introduced by the Internet Engineering Task Force (IETF), to address the various failings of TCP with respect to web applications. Notably, one major failing of TCP is that if any of the multiplexed data streams encounter an error, the entire connection is treated as failed. QUIC addresses these issues by multiplexing connections using UDP and letting the QUIC driver handle errors, instead of the transmission protocol. In essence, QUIC operates as HTTP/2 over UDP as a new Layer 4 protocol. In addition, QUIC supports including keying information within the initial handshake, as opposed to Transport Layer Security (TLS), which requires a separate handshake to secure the connection.

While QUIC is rapidly gaining acceptance, a key challenge lies in the fact that many network security systems treat QUIC connections as traditional Layer 4 UDP traffic and will block the connections. Indeed, many networks, by policy, simply block UDP traffic. QUIC proxies are also not yet a feature and most application layer protocols are designed for HTTP.

In addition, some browsers and applications now attempt to establish a QUIC connection, by default, without any prior knowledge of QUIC support by the network or target destination. This behavior is, at minimum, inefficient from the standpoint of the client and, at maximum, also impactful on the performance of the network itself. More specifically, if the attempted QUIC protocol connection times out due to QUIC not being supported along the path to the destination, the client then falls back to re-attempting a connection with the destination using TCP. In some cases, the client could simultaneously attempt both QUIC and TCP connection with the destination, but this also greatly increases the overhead on the network and on the client.

### Optimized QUIC Fallback on Access Networks and Endpoints

The techniques herein optimize the fallback behavior of QUIC-capable clients by proactively alerting the client when QUIC is not supported with the target destination of a connection. In some aspects, a DNS service may determine whether a QUIC protocol connection would be supported between a requesting client and a target destination, as part of the DNS lookup mechanism. In turn, the DNS service may include an indication as to this determination in its DNS response. This allows a policy to be installed at an intermediary between the client and destination, either locally on the client or at an intermediary device in the network. Thus, when the client attempts a QUIC protocol connection with the destination, the intermediary can explicitly reject the connection and triggering the client to use TCP, instead.

Specifically, according to one or more embodiments of the disclosure as described in detail below, a domain name system (DNS) service receives a DNS request sent by a client for a particular destination. The DNS service determines that a connection between the client and the particular destination will not support use of the Quick User Datagram Protocol (UDP) Internet Connections (QUIC) protocol. The DNS service generates a DNS response to the DNS request that includes an indication that the connection between the client and the particular destination will not support use of the QUIC protocol within an Extensions Mechanisms for DNS (EDNS) field of the DNS response. The DNS service sends the DNS response, to cause an intermediary between the client and the particular destination to explicitly reject a QUIC protocol connection attempted by the client with the particular destination.

Illustratively, the techniques described herein may be performed by hardware, software, and/or firmware, such as in accordance with the QUIC fallback optimization process 248, which may include computer executable instructions executed by the processor 220 (or independent processor of interfaces 210) to perform functions relating to the techniques described herein.

Operationally, the techniques herein introduce fail-fast and fail-close-to-initiator mechanisms such that clients, either readily or with minimal performance overhead, detect the unavailability of QUIC for a connection with a particular destination. For example, QUIC may not be supported for the connection with the destination for either or both of the following reasons:
1. The access network used by the client to communicate with the destination blocks QUIC connections by policy. For example, this may be due to a security policy in the network that blocks all outgoing UDP traffic, especially on port 443.
2. The target destination does not support the use of QUIC.

Before delving further into the optimization techniques introduced herein, it is important to first understand how firewalls and other access devices typically block connections. In general, firewalls and other access devices can use one of two mechanisms to block a connection:
1. Passively reject the connection by simply dropping the packets.
2. Explicitly reject the connection by signaling the rejection to the client.

For security reasons, the former approach is the approach typically taken by the firewall or other access device. This is because explicit signaling of the rejection could allow a malicious entity to gain information about the firewall or other access device. However, in the case of QUIC connections, passively rejecting a QUIC connection often leads to the client having to wait for the dropped connection to timeout, before re-attempting the connection using TCP.

According to various embodiments, a key aspect of the techniques herein proposes explicitly signaling back to the client a lack of QUIC support for the attempted connection, either due to the access network not allowing the use of QUIC or the target destination not supporting the use of the QUIC protocol.

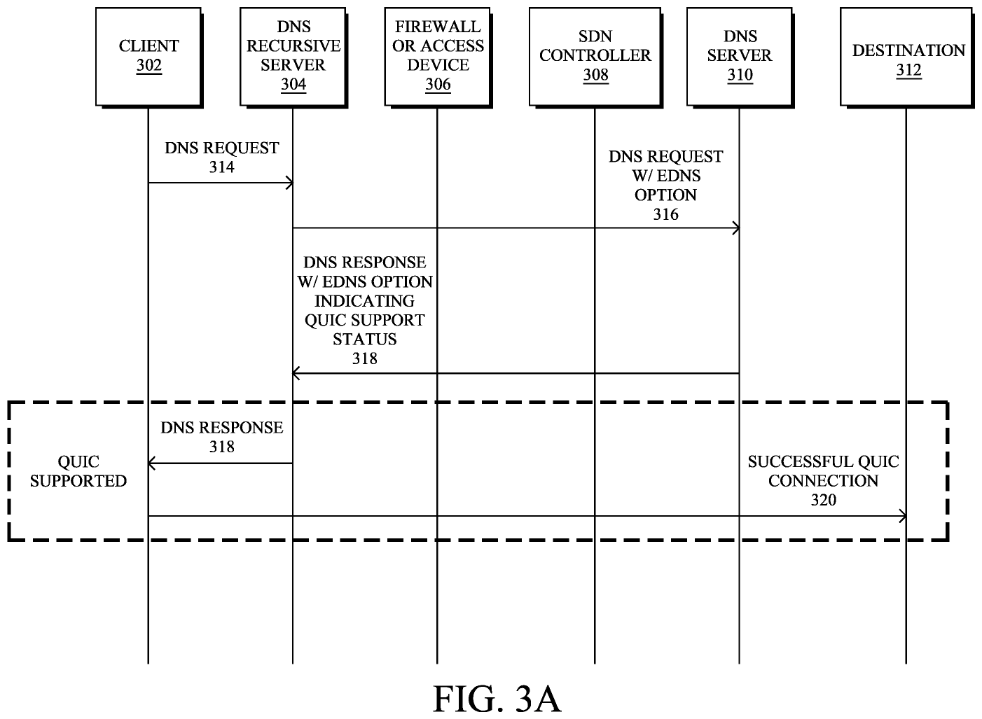

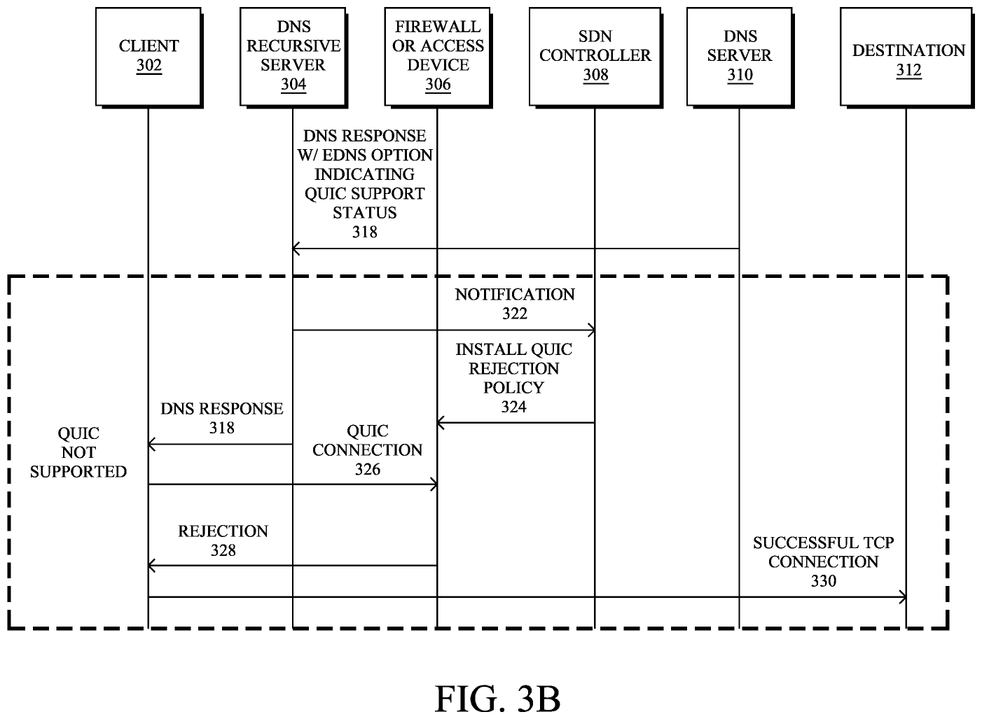

FIGS. 3A-3B illustrate example flow diagrams for optimized QUIC fallback in an access network, according to various embodiments. As shown in FIG. 3A, assume that any or all of the following entities are present in the network, to facilitate a connection between a client 302 and a particular destination 312 (e.g., a target server or domain) to which client 302 wishes to connect: a DNS recursive server 304, a firewall or other access device 306, a software defined networking (SDN) controller 308, and/or a DNS server 310.

As would be appreciated, most Internet connections are preceded by a DNS lookup of the intended destination of the connection. To perform such a lookup, the client issues a DNS request to a DNS service for a domain name. In turn, the DNS service looks up the IP address associated with that domain name and returns the address to the client in a DNS response. For example, the domain name “cisco.com” may resolve is to an IPv4 or IPv6 address, such as 2001:420:1101:1::185. Once the client knows the address of its intended destination, it sends a connection request to that address, to establish the desired connection.

Often, a DNS service is hierarchical in nature, with an access network having a DNS recursive server that maintains DNS address entries promulgated by an authoritative DNS server. For example, client 302 may send a DNS request 314 to DNS recursive server 304 for the address of destination 312. If DNS recursive server 304 is unable to fulfill this request, it may query another DNS server, such as DNS server 310. For example, DNS server 310 may be OpenDNS or another DNS service, while DNS recursive server 304 of the access network of client 302.

According to various embodiments, Extensions Mechanisms for DNS (EDNS) fields of a DNS response and/or DNS request can be used to convey information regarding the support of QUIC by the access network and/or destination 312. For example, as shown, in response to receiving DNS request 314 from client 302, DNS recursive server 304 may send a corresponding DNS request 316 to DNS server 310 with an EDNS option set, to request information regarding whether destination 312 supports QUIC.

In response to receiving DNS request 316, DNS server 310 may determine whether destination 312 supports QUIC protocol connections. DNS server 310 may do in any number of ways. In one embodiment, DNS server 310 may have previously crawled the domain of destination 312, to discern whether it supports QUIC. In another embodiment, DNS server 310 may receive information regarding whether destination 312 supports QUIC from another service or device. In a further embodiment, if DNS server 310 does not know whether destination 312 supports QUIC, DNS server 310 may itself try to establish a just-in-time QUIC connection with destination 312.

Once DNS server 310 determines the QUIC support status of destination 312, as well as its queried address, DNS server 310 may generate a DNS response 318 that includes an indication as to whether destination 312 supports QUIC within the EDNS is option field of DNS response 318. In turn, DNS server 310 may send DNS response 318 back to DNS recursive server 304.

One of two possibilities exist, with respect to DNS response 318. If DNS response 318 indicates that destination 312 supports QUIC connections, DNS recursive server 304 may simply provide DNS response 318 back to client 302, as shown in the scenario depicted in FIG. 3A. In turn, client 302 may proceed to establish a successful QUIC connection 320 with destination 312, using the address returned in DNS response 318.

As shown in FIG. 3B, now assume that the EDNS option of DNS response 318 instead indicates that destination 312 does not support QUIC protocol connections. In such a case, DNS recursive server 310 may send a notification 322 to SDN controller 308, indicating that client 302 is going to attempt to connect with destination 312 using QUIC. In response, SDN controller 308 may then send a message 324 to firewall or other access device 306 and/or any other intermediary device in the network, to install a QUIC rejection policy for destination 312.

According to various embodiments, the installed QUIC rejection policy may require firewall or other access device 306 to explicitly reject any attempt by client 302 to establish a QUIC connection with destination 312. Of course, in further embodiments, if a security policy is likewise in effect in the access network, such as to block all outgoing UDP, the installed QUIC rejection policy may instruct firewall or access device 306 to explicitly reject a QUIC connection between client 302 and destination 312.

When DNS recursive server 304 returns DNS response 318 to client 302, client 302 will then attempt to form a QUIC protocol connection 326 with destination 312, using the address returned in DNS response 318. In response, however, firewall or access device 306 may block the attempted connection 326 and provide an explicit rejection 328 back to client 302. For example, in some embodiments, rejection 328 may take the form of Internet Control Message Protocol (ICMP) signaling, such as a is “communication administratively prohibited” or “destination protocol unreachable” message.

Thus, by firewall or other access device 306 explicitly rejecting QUIC connection 326, client 302 can immediately fall back to TCP and successfully establish a TCP connection 330 with destination 312. Such an explicit rejection 328 also means that client 302 does not need to wait for the attempted QUIC connection 326 to timeout, before initiating TCP connection 330.

In some cases, it may be possible that DNS server 310 does not have information regarding whether destination 312 supports QUIC or the access network does not make use of an intelligent DNS server 310 capable of making such a determination. Accordingly, in further embodiments, DNS recursive server 304 may indicate as such in notification 322. In response, SDN controller 308 may install a ‘report’ policy on firewall or other access device 306 and/or any other intermediary. Under such a policy, device 306 may monitor whether the subsequently attempted QUIC connection 326 with destination 312 fails and client 302 falls back to establishing a TCP connection 330, instead. If so, device 306 may report this failure to SDN controller 308, so that a QUIC rejection policy can be put into effect. In a further embodiment, SDN controller 308 could also periodically probe destination 312, to discern whether destination 312 supports QUIC.

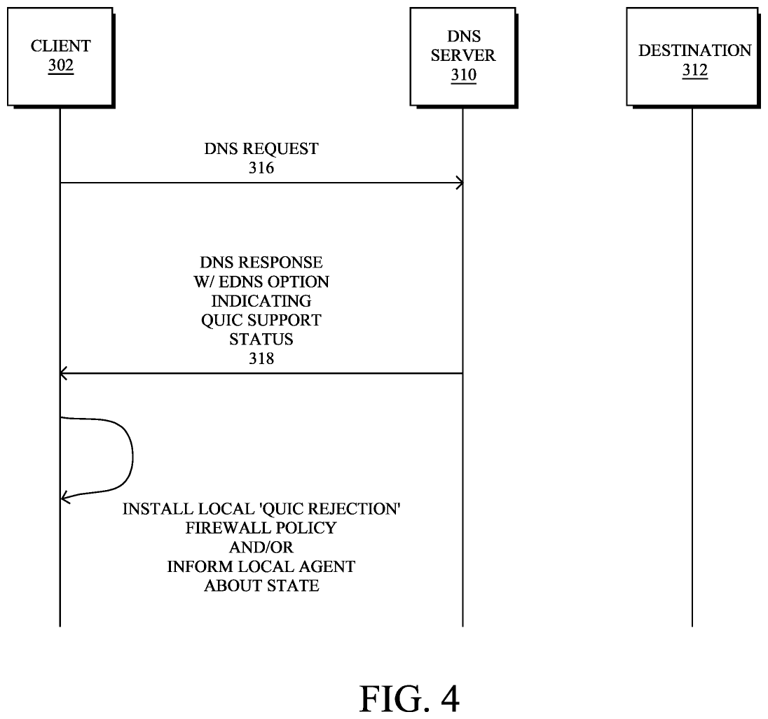

FIG. 4 illustrates an example flow diagram for optimized QUIC fallback on a local client 302. In further embodiments, rather than an intermediary device between client 302 and destination 312 explicitly rejecting an attempted QUIC connection, a local firewall or other agent executed locally on client 302 could also make the rejection. For example, many enterprise clients execute local security software/agents such as AnyConnect Roaming Security by Cisco Systems, Inc., or the like, to help protect the local client device. Associated with such an agent may be an intelligent DNS service, such as OpenDNS.

As shown, client 302 may send a DNS request 316 to DNS server 310, to perform is a lookup for the address of destination 312. Similar to the example shown in FIGS. 3A-3B, DNS server 310 may then determine whether destination 312 supports QUIC or not and provide an indication of the determination within the EDNS option of its resulting DNS response 318.

If destination 312 does not support QUIC, as indicated by DNS response 318, client 302 may install a local QUIC rejection policy to its local firewall and/or notify its local security agent as to destination 312 not supporting QUIC. In turn, when a browser or other application on client 302 attempts to establish a QUIC connection with destination 312, the local firewall or other agent on client 302 can explicitly reject the attempted QUIC connection with destination 312, causing the browser or other application to fall back to attempting to connect with destination 312 using TCP.

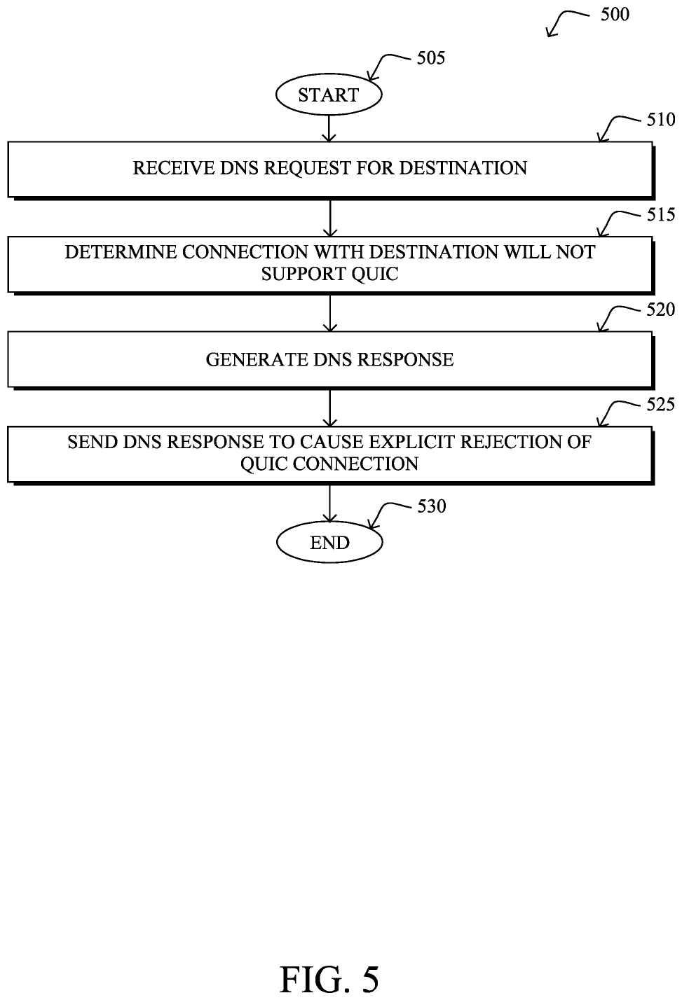

FIG. 5 illustrates an example simplified procedure for causing the explicit rejection of a QUIC connection, in accordance with one or more embodiments described herein. For example, a non-generic, specifically configured device (e.g., device 200) may perform procedure 500 by executing stored instructions (e.g., process 248). For example, in various embodiments, the device may provide a DNS service to a network. The procedure 500 may start at step 505, and continues to step 510, where, as described in greater detail above, the DNS service may receive a DNS request sent by a client for a particular destination.

At step 515, as detailed above, the DNS service may determine that a connection between the client and the particular destination will not support use of the QUIC protocol. In various embodiments, the service may do so by previously attempting to establish a QUIC connection with the destination (e.g., by crawling the destination), attempting a just-in-time QUIC connection with the destination (e.g., after receiving the DNS request for the destination), or based on information provided by a 3^{rd} party or directly from the destination itself.

At step 520, the DNS service may generate a DNS response to the DNS request, as described in greater detail above. In various embodiments, the generated DNS is response may include an indication that the connection between the client and the particular destination will not support use of the QUIC protocol within an EDNS field of the DNS response.

At step 525, as detailed above, the DNS service may send the generated DNS response, to cause an intermediary between the client and the particular destination to explicitly reject a QUIC protocol connection attempted by the client with the particular destination. In some embodiments, the intermediary may comprise a firewall or access device. In further embodiments, the intermediary may comprise a local agent or local firewall of the client. Such an intermediary may explicitly reject the QUIC protocol connection attempted by the client using, for example, ICMP signaling back to the client. In turn, the client may attempt a TCP connection with the particular destination, in response to the explicit rejection of the attempted QUIC protocol connection by the intermediary. In yet another embodiment, the DNS response causes a software defined networking (SDN) controller to install a policy on the intermediary to explicitly reject the QUIC protocol connection attempted by the client with the particular destination. Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, introduce an optimized approach to causing a client to fall back to using TCP instead of attempting to connect with a particular destination via QUIC. In some aspects, the DNS lookup phase that precedes an attempted connection with a destination can be enhanced to also discern whether the target destination supports the use of QUIC. In turn, an intermediary, either local to the client itself or associated with the access network, can use this information to explicitly is reject the QUIC connection attempted by the client. By doing so, the client no longer needs to wait for the QUIC connection to timeout before reattempting to connect with the destination using TCP and reducing the overall time to connect.

While there have been shown and described illustrative embodiments that provide for an optimized QUIC fallback mechanism, it is to be understood that various other adaptations and modifications may be made within the spirit and scope of the embodiments herein. For example, while certain protocols are shown, such as QUIC, HTTP, and IPv6, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a domain name system (DNS) service, a DNS request sent by a client for a particular destination;
determining, by the DNS service, that a connection between the client and the particular destination will not support use of the Quick User Datagram Protocol (UDP) Internet Connections (QUIC) protocol;
generating, by the DNS service, a DNS response to the DNS request that includes an indication that the connection between the client and the particular destination will not support use of the QUIC protocol within an Extensions Mechanisms for DNS (EDNS) field of the DNS response; and
sending the DNS response, by the DNS service, to cause an intermediary between the client and the particular destination to explicitly reject a QUIC protocol connection attempted by the client with the particular destination.

2. The method as in claim 1, wherein determining that a connection between the client and the particular destination will not support use of the QUIC protocol comprises:
attempting, by the DNS service, a QUIC protocol connection with the particular destination.

3. The method as in claim 1, wherein the client attempts a Transmission Control Protocol (TCP) connection with the particular destination, in response to the explicit rejection of the attempted QUIC protocol connection by the intermediary.

4. The method as in claim 1, wherein the intermediary between the client and the particular destination comprises a local agent or local firewall of the client.

5. The method as in claim 1, wherein the intermediary uses Internet Control Message Protocol (ICMP) signaling to explicitly reject the QUIC protocol connection attempted by the client.

6. The method as in claim 1, wherein the intermediary comprises a firewall or access device.

7. The method as in claim 6, wherein the DNS response causes a software defined networking (SDN) controller to install a policy on the intermediary to explicitly reject the QUIC protocol connection attempted by the client with the particular destination.

8. The method as in claim 6, wherein the intermediary probes the particular destination for QUIC protocol support, subsequent to explicitly rejecting the QUIC protocol connection attempted by the client with the particular destination.

9. An apparatus, comprising:
one or more network interfaces to communicate with a network;
a processor coupled to the network interfaces and configured to execute one or more processes; and
a memory configured to store a process executable by the processor, the process when executed configured to:
receive a DNS request sent by a client for a particular destination;
determine that a connection between the client and the particular destination will not support use of the Quick User Datagram Protocol (UDP) Internet Connections (QUIC) protocol;
generate a DNS response to the DNS request that includes an indication that the connection between the client and the particular destination will not support use of the QUIC protocol within an Extensions Mechanisms for DNS (EDNS) field of the DNS response; and
send the DNS response, to cause an intermediary between the client and the particular destination to explicitly reject a QUIC protocol connection attempted by the client with the particular destination.

10. The apparatus as in claim 9, wherein the apparatus determines that a connection between the client and the particular destination will not support use of the QUIC protocol by:
attempting a QUIC protocol connection with the particular destination.

11. The apparatus as in claim 9, wherein the client attempts a Transmission Control Protocol (TCP) connection with the particular destination, in response to the explicit rejection of the attempted QUIC protocol connection by the intermediary.

12. The apparatus as in claim 9, wherein the intermediary between the client and the particular destination comprises a local agent or local firewall of the client.

13. The apparatus as in claim 9, wherein the intermediary uses Internet Control Message Protocol (ICMP) signaling to explicitly reject the QUIC protocol connection attempted by the client.

14. The apparatus as in claim 9, wherein the intermediary comprises a firewall or access device.

15. The apparatus as in claim 14, wherein the DNS response causes a software defined networking (SDN) controller to install a policy on the intermediary to explicitly reject the QUIC protocol connection attempted by the client with the particular destination.

16. The apparatus as in claim 14, wherein the intermediary probes the particular destination for QUIC protocol support, subsequent to explicitly rejecting the QUIC protocol connection attempted by the client with the particular destination

17. A tangible, non-transitory, computer-readable medium storing program instructions that cause a domain name system (DNS) service to execute a process comprising:
receiving, at the DNS service, a DNS request sent by a client for a particular destination;
determining, by the DNS service, that a connection between the client and the particular destination will not support use of the Quick User Datagram Protocol (UDP) Internet Connections (QUIC) protocol;
generating, by the DNS service, a DNS response to the DNS request that includes an indication that the connection between the client and the particular destination will not support use of the QUIC protocol within an Extensions Mechanisms for DNS (EDNS) field of the DNS response; and
sending the DNS response, by the DNS service, to cause an intermediary between the client and the particular destination to explicitly reject a QUIC protocol connection attempted by the client with the particular destination.

18. The computer-readable medium as in claim 17, wherein determining that a connection between the client and the particular destination will not support use of the QUIC protocol comprises:
attempting, by the DNS service, a QUIC protocol connection with the particular destination.

19. The computer-readable medium as in claim 17, wherein the intermediary between the client and the particular destination comprises a local agent or local firewall of the client.

20. The computer-readable medium as in claim 17, wherein the intermediary uses Internet Control Message Protocol (ICMP) signaling to explicitly reject the QUIC protocol connection attempted by the client.
